(19) United States
(12) Patent Application Publication
(10) Pub. No.: US 2013/0175288 A1
(43) Pub. Date: Jul. 11, 2013

(54) Method For Providing A Tablet Supply Channel For A Unit For Releasing Tablets, A Tablet Releasing Unit, And Use Of A Slot Miller For Providing The Tablet Supply Channel For The Tablet Releasing Unit

(71) Applicant: MARCHESINI GROUP S.P.A., Pianoro (Bologna) (IT)

(72) Inventor: Giuseppe MONTI, Pianoro (Bologna) (IT)

(73) Assignee: MARCHESINI GROUP S.P.A., Pianoro (Bologna) (IT)

(21) Appl. No.: 13/734,226

(22) Filed: Jan. 4, 2013

(30) Foreign Application Priority Data
Jan. 9, 2012 (IT) BO2012A 000008

(51) Int. Cl. B65D 83/04; B23C 3/28

(52) U.S. Cl. CPC B65D 83/04; B23C 3/28
USPC 221/65; 409/131

(57) ABSTRACT

A method is described for providing a tablet supply channel in a support (5) of a tablet releasing unit (10), with a slot miller providing the tablet supply channel. The method includes milling the tablet supply channel (6) in the support (5). The supply channel (6) exhibits a transversal section that is practically constant, and has an opening (7) developed along a length thereof. The milled supply channel embraces the transiting tablets (2) using a main wall (11), a first lateral wall (12) connected to the main wall, a second lateral wall (13) connected to the main wall (11), which is opposite the first lateral wall. The milling is performed using a slot miller having a cutting profile which is alike to an external tablet profile of one equal part of a transversal section of maximum area, so that the tablet (2) is guided along the supply channel (6).

### FIELD OF THE INVENTION

The present invention relates to the technical sector concerning supports which form supply channels through which tablets can transit. These tablets, for example, can be subsequently released internally of the cells of a celled strip which is subsequently sealed and cut so as to form a blister pack of tablets.

In particular, the invention relates to a method for realizing at least one supply channel of tablets in a support of a unit for release of tablets, to a unit for release of tablets and to a use of a slot miller for realizing at least one supply channel of tablets in a support of a unit for release of tablets.

### DESCRIPTION OF THE PRIOR ART

FIGS. 1, 2 illustrate a unit (1) for releasing tablets (2), of the known type.

The unit (1) comprises a support (5) which conforms at least one supply channel (6) of tablets (2). Each supply channel (6) of tablets (2) exhibits a transversal section that is practically constant, exhibits an opening (7) which develops along the relative length thereof and is conformed such as to embrace the transiting tablets (2).

The tablets (2) which are used are generally oval in shape.

In the example illustrated in FIGS. 4, 5, the tablet is oblong and has a longitudinal axis, and exhibits a longitudinal plane of symmetry, which contains the longitudinal axis, and a transversal plane of symmetry which is perpendicular to the longitudinal plane of symmetry. This tablet has a main body (3) and two identical ends (4). The main body has a constant transversal section and a maximum area (17). It could be said that the transversal section of maximum area (17) has a profile that can contain the profile of all the other transversal sections of the tablet (2), which in the present example are the transversal sections of the relative end (4). This means that the projection on a perpendicular plane to the longitudinal axis of the tablet of the profile of the transversal section of maximum area (17) includes all the other projections, on the same perpendicular plane to the longitudinal axis of the tablet, of the remaining profiles of the transversal sections of the tablet.

Further, the transversal section of maximum area (17) has two axes of symmetry, one which lies on the longitudinal plane of symmetry and the other which lies on the transversal plane of symmetry.

Each supply channel (6) of tablets is usually obtained by milling.

The supply channel (6) of tablets forms, in particular, a main wall (11); a first lateral wall (12) which is connected to the main wall (11); a second lateral wall (13) which is connected to the main wall (11) and which is opposite the first lateral wall (12).

Thereafter, the supply channels (6) of tablets are laterally closed, i.e. on the side of the relative openings (7), by means of a transparent panel (8) (FIG. 2) which is fixed by fixing means (9) to the support (5). The transparent panel (8) has not been illustrated in FIG. 1 in order better to show the supply channels (6) of tablets (2).

The shapes of tablets are progressively becoming more complex, while still maintaining some basic geometrical characteristics. As a consequence it can happen that a tablet might rotate anomalously along the supply channel and get blocked internally thereof, forming a cap which blocks the transit of the tablets that follow. The operator is then forced to halt the production line, remove the transparent panel (8) and extract the tablet which has caused the blockage. This operation obviously requires a certain amount of time and can lead to wasting of some treated products along the production line, for example a portion of celled strip already containing a certain number of tablets.

### SUMMARY OF THE INVENTION

The aim of the present invention consists in obviating the above-described drawbacks.

The above aim has been attained with a unit for releasing tablets, with a method for realizing at least one supply channel of tablets in a support of a unit for release of tablets, and by using a slot miller for realizing at least one supply channel of tablets in a support of a unit for release of tablets.

Each tablet is advantageously constantly guided by the supply channel of tablets during the transit thereof internally of the supply channel of tablets. Each tablet has a transversal section of maximum area, a profile of which completely brushes the walls of the supply channel, and it is therefore not possible for the tablet to rotate anomalously during transit thereof along the supply channel of tablets. It is therefore no longer possible for a tablet to form an obstruction along the supply line.

Further, the use of a slot miller leads to forming a lateral opening of small dimension, such that a tablet cannot exit laterally from the supply channel through the opening. Therefore, the use of a transparent closing panel becomes superfluous and it is thus possible for an operator to intervene immediately on the supply channel should the improbable situation of an obstruction or the like occur in the supply channel.

### BRIEF DESCRIPTION OF THE DRAWINGS

Specific embodiments of the invention will be described in the following part of the present description, according to what is set out in the claims and with the aid of the accompanying drawings, in which:

FIG. 1 is a lateral view of a release unit of tablets of known type;

FIG. 2 is a view of section II-II of FIG. 1;

FIG. 3 is a view of enlarged-scale detail K1 of FIG. 2;

FIGS. 4, 5 are respectively a front and lateral view in enlarged scale of a first type of tablet;

FIG. 6 is a lateral view of a unit for release of tablets according to a first embodiment of the invention;

FIG. 7 is a view of section VII-VII of FIG. 6;

FIG. 8 is a front view in enlarged scale of a second type of tablet;

FIG. 9 is a view of detail K2 in enlarged view of FIG. 7;

FIG. 10 is a lateral view of a unit for release of tablets in accordance with a second embodiment of the invention;

FIG. 11 is the view along section XI-XI of FIG. 10;

FIG. 12 is a front view in enlarged scale of a third type of tablet; and,

FIG. 13 is a view in enlarged scale of enlarged detail K3 of FIG. 11.

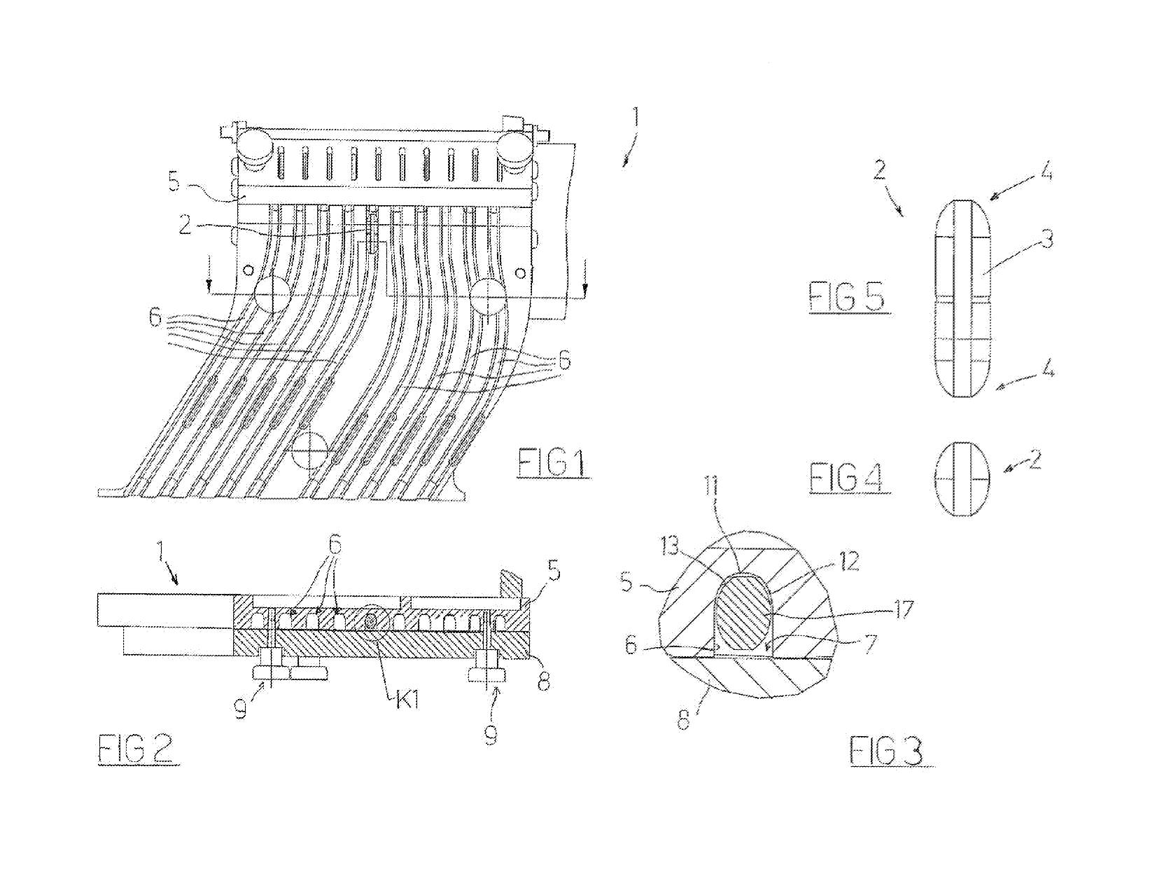

### DESCRIPTION OF PREFERRED EMBODIMENTS

With reference to the accompanying tables of drawings, general reference numeral (10) is a unit for release of tablets (2).

These tablets (2), for example, can be subsequently released internally of the cells of an underlying celled strip (not illustrated) which is subsequently sealed and cut to form a blister pack of tablets (2).

The unit (1) comprises a support (5) which forms a plurality of supply channels (6) of tablets (2). Each supply channel (6) of tablets (2) exhibits a practically constant transversal section (16) along the length thereof and is conformed so as to embrace the transiting tablets (2).

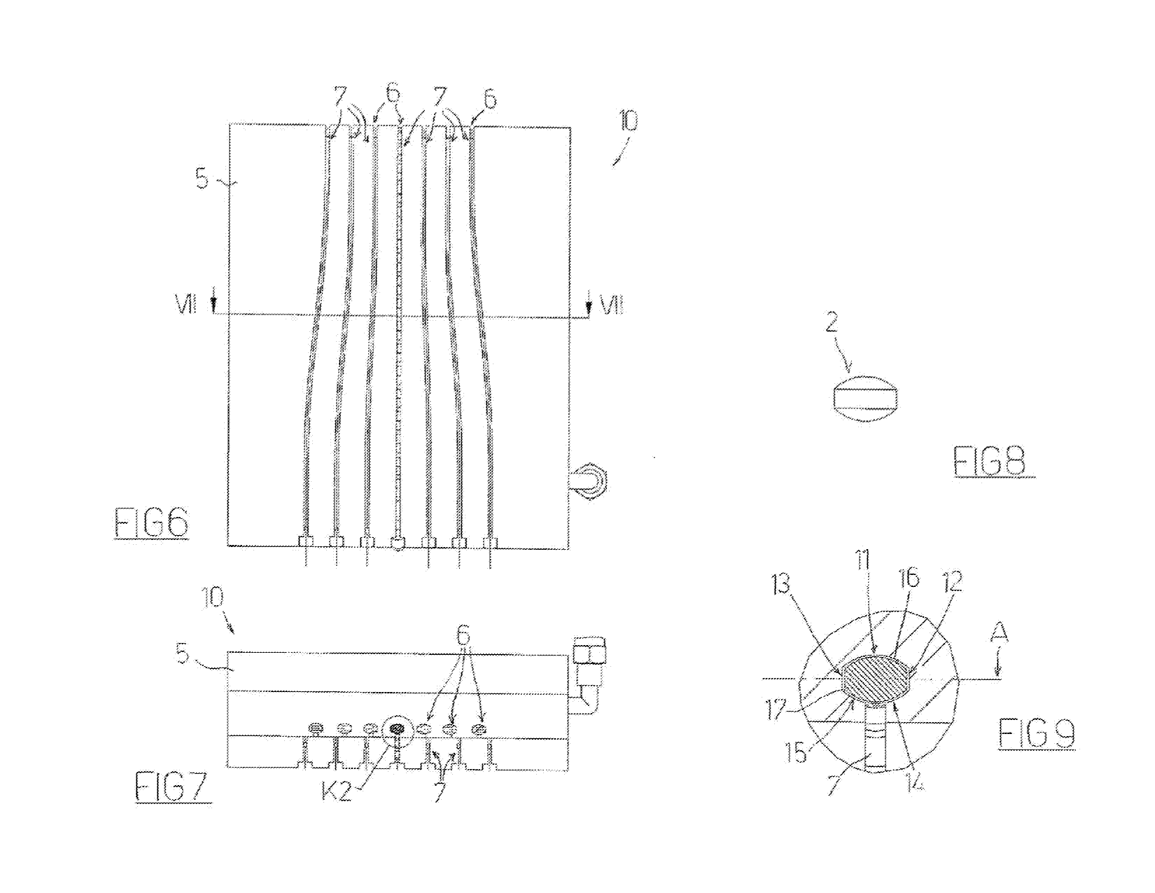

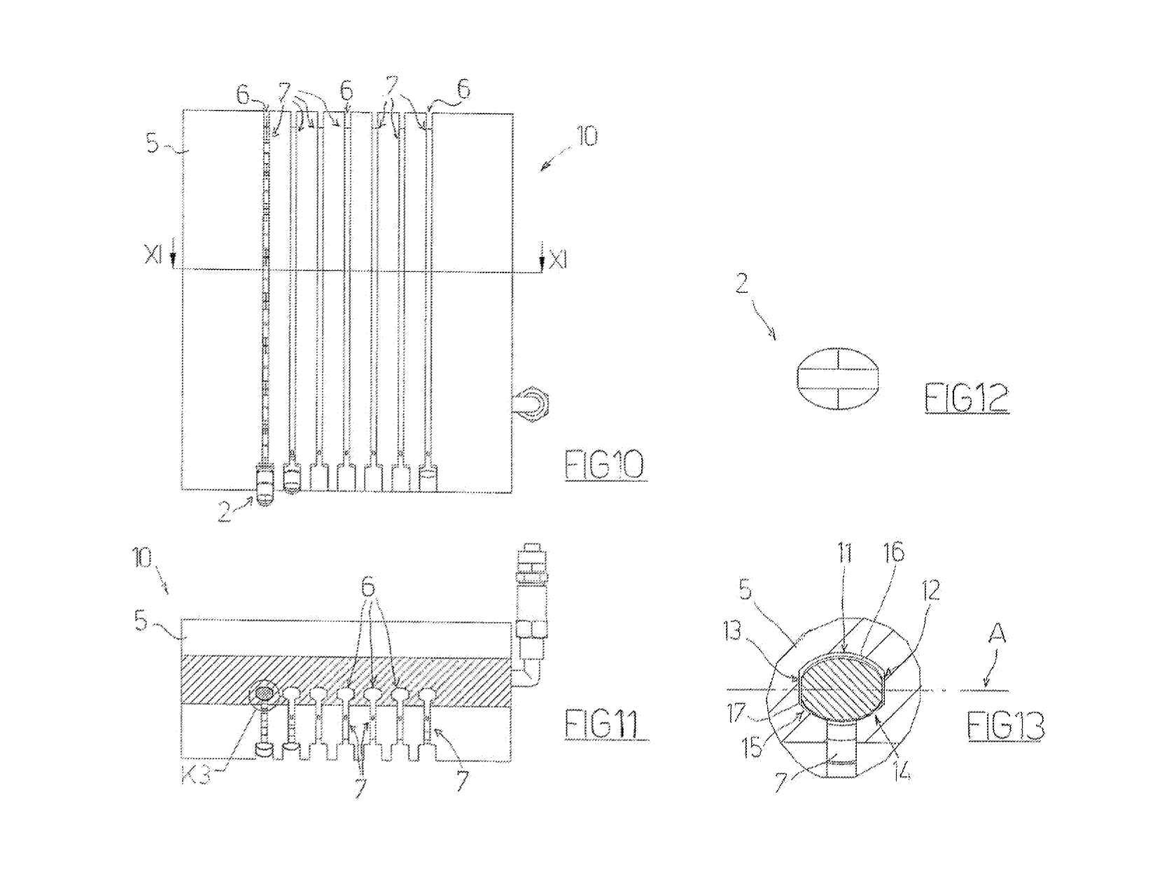

FIGS. 4, 5 illustrate a first type of tablet (2), while FIGS. 8 and 12 illustrate respectively a second and a third type of tablet (2).

In general terms, the invention is usable with tablets (2) each having a longitudinal axis and a transversal section (17) of maximum area which has a profile that can contain the profile of all the other transversal sections of the tablet (2) and which has an axis of symmetry (A) which divides the transversal section (17) of maximum area into two equal parts.

This is to say that the projection onto a plane perpendicular to the longitudinal axis of the tablet (2) of the profile of the transversal section of maximum area (17) includes all the other projections, on the perpendicular plane to the longitudinal axis of the tablet, of the remaining profiles of the transversal sections of the tablet (2).

The supply channel (6) forms a main wall (11), a first lateral wall (12) which is connected to the main wall (11), a second lateral wall (13) which is connected to the main wall (11) and which is opposite the first lateral wall (12), a first auxiliary wall (14) which is connected to the first lateral wall (21) and which is opposite the main wall (11), and, a second auxiliary wall (15) which is connected to the second lateral wall (13) and which is opposite the main wall (11).

The first auxiliary wall (14) and the second auxiliary wall (15) delimit the opening (7).

The main wall (11), the main lateral wall (12), the second lateral wall (13), the first auxiliary wall (14) and the second auxiliary wall (15) are conformed such that the transversal section (16) of the supply channel (6) exhibits a profile having the same shape as the profile of the transversal section (17) of maximum area of the tablet (2), such that the tablet (2) is guided along the supply channel (6).

The unit (10) and the tablets (2) cited above form a group.

FIGS. 6, 7 illustrate a first embodiment of the unit (10), while FIGS. 10, 11 illustrate a second embodiment of the unit (10). These embodiments are distinguished from one another essentially by the different shape of the supply channels (6) which in turn are designed according to the shape of the tablets (2) which can slide along the supply channels (6) and the arrangement that the tablets (2) have to assume inside the cells of the underlying celled strip. The present invention further defines a method for realizing at least one supply channel (6) for tablets (2) in a support (5) of a unit (10) for releasing tablets (2). The method comprises a step of realizing, by milling, at least one supply channel (6) of tablets (2) in the support (5) of the unit (6) for releasing tablets (2), such that the supply channel (6) of tablets (2) exhibits a constant transversal section, exhibits an opening (7) which develops along the relative length thereof, is conformed so as to embrace the tablets (2) in transit, and, forms a main wall (11), a first lateral wall (12) which is connected to the main wall (11), a second lateral wall (13) which is connected to the main wall (11) and which is opposite the first lateral wall (12).

In particular, the milling is done using a slot miller (not illustrated) comprising a stalk and a head having a cutting profile which is similar to the external profile of one of the two identical parts of the transversal section (17) of maximum area.

The milling is done in such a way that the supply channel (6) obtained also forms a first auxiliary wall (14) which is connected to the first lateral wall (12) and which is opposite the main wall (11), and a second auxiliary wall (15) which is connected to the second lateral wall (13) and which is opposite the main wall (11), the first auxiliary wall (14) and the second auxiliary wall (15) delimiting the opening (7). Further, the milling is performed in such a way that the transversal section (16) of the supply channel (6) exhibits a profile having the same shape as the profile of the transversal section (17) of maximum area of the tablet (2), such that the tablet (2) is guided along the supply channel (6). Each tablet (2) is thus constantly guided by the supply channel (6) of tablets (2) during transit thereof internally of the supply channel (6) of tablets (2). Each tablet (2) has a transversal section (17) of maximum area, a profile of which brushes the walls of the supply channel (6) and therefore it is no longer possible for the tablet to rotate anomalously during transit thereof along the supply channel (6) of tablets (2). It is therefore no longer possible for a tablet (2) to form an obstacle along the supply channel (6).

Further, the use of a slot miller leads to the formation of a lateral opening (7) of small dimensions, such that a tablet (2) cannot exit laterally from the supply channel (6) through the opening (7). Thus the use of a transparent closing panel becomes superfluous and thus it is possible for an operator to intervene immediately on the supply channel (6) in the case, by now very improbable, that a blockage is caused or the like in the supply channel (6). Further, this constructional solution simplifies and accelerates the cleaning and hygienizing operations of the support (5).

The invention further defines a use of a slot miller, having the above-described characteristics, for realizing at least a supply channel (6) of tablets (2) in a support (5) of a unit (10) for release of tablets (2).

The above has been described by way of non-limiting example, and any eventual constructional variants are understood to fall within the protective scope of the present technical solution, as claimed in the following.

1. A unit (10) for releasing tablets (2) having a longitudinal axis and a transversal section (17) having a maximum area which has a profile that can contain the profile of all other transversal sections of the tablet (2) and which has an axis of symmetry (A) that divides the transversal section (17) of maximum area into two equal parts, the unit (10) comprising:
a support (5) which conforms at least one tablet supply channel (6), the tablet supply channel (6) obtained by milling, and exhibiting a transversal section that is practically constant, the tablet supply channel having an opening (7) which develops along a relative length thereof and is conformed so as to embrace tablets (2) transiting therethrough;
the tablet supply channel (6) having a main wall (11), a first lateral wall (12) which is connected to the main wall (11), a second lateral wall (13) which is connected to the main wall (11) and which is opposite the first lateral wall (12), a first auxiliary wall (14) which is connected to the first lateral wall (12) and which is opposite the main wall (11), and a second auxiliary wall (15) which is connected to the second lateral wall (13) and which is opposite the main wall (11);
wherein the first auxiliary wall (14) and the second auxiliary wall (15) delimit the opening (7);
wherein the main wall (11), the first lateral wall (12), the second lateral wall (13), the first auxiliary wall (14) and the second auxiliary wall (15) are conformed such that the transversal section (16) of the supply channel (6) exhibits a profile having a same shape as the profile of the transversal section (17) of maximum area of the tablet (2), such that the tablet (2) is guided along the supply channel (6).

2. A method for realizing at least one tablet supply channel (6) in a support (5) of a unit (10) for releasing tablets (2), each tablet (2) having a longitudinal axis and a transversal section (17) of maximum area which has a profile that contains the profile of all the other transversal sections of the tablet (2) and which has an axis of symmetry (A) that divides the transversal section (17) of maximum area into two equal parts, the method comprising the steps of:
realizing, by milling, at least one supply channel (6) of tablets (2) in a support (5) of a unit (10) for releasing tablets (2), the tablet supply channel (6): exhibiting a transversal section that is practically constant, the tablet supply channel having an opening (7) which develops along a relative length thereof, the tablet supply channel being conformed so as to embrace tablets (2) thansiting therethrough, the tablet supply channel having a main wall (11), a first lateral wall (12) which is connected to the main wall (11), a second lateral wall (13) which is connected to the main wall (11) and which is opposite the first lateral wall (12);
performing the milling using a slot miller having a shank and a head having a cutting profile which is alike to an external profile of one of the two equal parts of the transversal section (17) of maximum area,
thereby obtaining a tablet supply channel (6) further having a first auxiliary wall (14) which is connected to the first lateral wall (12) and which is opposite the main wall (11), and a second auxiliary wall (15) which is connected to the second lateral wall (13) and which is opposite the main wall (11), the first auxiliary wall (14) and the second auxiliary wall (15) delimiting the opening (7),
wherein the transversal section (16) of the supply channel (6) exhibits a profile having a same shape as a shape of the profile of the transversal section (17) of maximum area of the tablet (2), the supply channel thereby guiding the tablet (2) along the supply channel (6).

3. Use of a slot miller for realizing at least one tablet supply channel (6) in a support (5) of a unit (10) for release of tablets (2), each tablet (2) having a longitudinal axis and a transversal section (17) of maximum area which has a profile that can contain the profile of all other transversal sections of the tablet (2) and which has an axis of symmetry (A) that divides the transversal section (17) of maximum area into two equal parts, the slot miller comprising a shank and a head having a cutting profile which is alike to an external profile of one of the two equal parts of the transversal section (17) of maximum area, such that the milled supply channel (6) of tablets (2) exhibits a transversal section that is practically constant, and which has an opening (7) that develops along a relative length thereof, the tablet supply channel being conformed so as to embrace tablets (2) transiting therethrough, the tablet supply channel having a main wall (11), a first lateral wall (12) that is connected to the main wall (11), a second lateral wall (13) that is connected to the main wall (11) and that is opposite the first lateral wall (12), a first auxiliary wall (14) that is connected to the first lateral wall (12) and that is opposite the main wall (11), and a second auxiliary wall (15) that is connected to the second lateral wall (13) and that is opposite the main wall (11), wherein the first auxiliary wall (14) and the second auxiliary wall (15) delimit the opening (7), and wherein the transversal section (16) of the supply channel (6) exhibits a profile having a same shape as a profile of the transversal section (17) of maximum area of the tablets (2), thereby guiding the tablet (2) along the supply channel (6).
